(19) United States
(12) Patent Application Publication
(10) Pub. No.: US 2025/0216543 A1
(43) Pub. Date: Jul. 3, 2025

(54) IMPROVED SPATIAL SMOOTHING METHOD FOR GENERATING AN AUTOCORRELATION MATRIX OF RADIO SIGNAL MEASUREMENT VALUES

(71) Applicant: LAMBDA:4 ENTWICKLUNGEN GMBH, Hamburg (DE)

(72) Inventor: Rönne REIMANN, Hamburg (DE)

(73) Assignee: LAMBDA:4 ENTWICKLUNGEN GMBH, Hamburg (DE)

(21) Appl. No.: 18/853,496

(22) PCT Filed: May 16, 2022
(86) PCT No.: PCT/EP2022/063154

§ 371 Date: Oct. 2, 2024

(51) Int. Cl. G01S 13/84

(52) U.S. Cl. CPC G01S 13/84

(57) ABSTRACT

A method for providing an autocorrelation matrix of measurement values of wireless signals between a first and a second object for determining at least one property of the signal propagation of the wireless signals between the first and the second object having f, frequency measurement value vectors, each frequency measurement value vectors having a coordinates with a>=1 and with f>1 which are provided. An autocorrelation matrix with a frequency vector number smaller than f is formed from the set of frequency measurement value vectors by means of spatial smoothing for performing spatial smoothing, a plurality of subspace matrices each having a number of frequency measurement value vectors are formed and wherein the subspace matrices are each correlated with themselves and the subspace matrices correlated with themselves are added up.

### TECHNICAL FIELD

The invention relates to the evaluation of properties of a signal propagation of wireless signals, in particular the determination of the distance and/or the provision of mathematical objects, which are obtained from measurement values of wireless signals, for determining the properties of the signal propagation.

### BACKGROUND ART

Methods are known for generation of an autocorrelation matrix from complex measurement values and for determining at least a part of its eigenvalues and/or eigenvectors in order to determine properties of the signal propagation, such as the distance travelled and/or the direction of incidence of the signal. One of the methods called MUSIC, CAPON's method or MATRIX PENCIL is widely used for this.

A method is also known in which spatial smoothing is used to reduce a measurement value space and to determine a distance that a wireless signal has travelled between two objects from an autocorrelation matrix of measurement values of received wireless signals, whether generated with or without spatial smoothing.

For spatial smoothing, subspace matrices of the size g×a are formed from a measurement value matrix of the dimension f×a and thus, for example, a antenna measurement value vectors with measurement values at an at least approximately uniform frequency but a different antenna paths and f frequency measurement value vectors with measurement values at f different frequencies of an antenna path in each case, where g<f. The number of subspace matrices is (f−g+1).

The subspace matrices U(j) where j=1 . . . (f−g+1) are then formed as follows: U(j) is formed from the frequency measurement value vectors j to g+j−1 of the measurement value matrix in the order of the frequency measurement value vectors in the measurement value matrix. The subspace matrices are then correlated with themselves. The autocorrelated subspace matrices are then added together to form the autocorrelation matrix. g, a, f and j are positive integers here.

The autocorrelation matrix can then be used to apply known methods for handling autocorrelation matrices of measurement values, for example to reduce noise components and/or multiply test vectors with the autocorrelation matrix, its inverse or its eigenvector space. One of the methods called MUSIC, CAPON's method or MATRIX PENCIL is widely used for this.

A method is also known from “An Improved Spatial Smoothing Technique for DoA Estimation of Highly Correlated Signals”, Avi Abu, Engineering Letters, 19:1, EL 19 1 02 (Advance online publication: 10 Feb. 2011) in which the eigenvalues of the subspace matrices otherwise used for spatial smoothing are used directly to determine the angle of incidence using MUSIC without first adding up the subspace matrices.

### SUMMARY OF THE INVENTION

The object is to present an improved derivation of an autocorrelation matrix that allows the size of the autocorrelation matrix to be smaller but still allows the analyses to be as accurate as possible. By selecting the number of subspace matrices, the computing time can be chosen relatively freely, even with a given size of the autocorrelation matrix, and with a small number the computing time can be significantly reduced, and with a large number the accuracy of the data derived from the autocorrelation matrix can even be increased compared with the state of the art. However, excessive rounding errors in the computation must be avoided.

The object is achieved by a method for providing an autocorrelation matrix of measurement values of wireless signals between a first and a second object for determining at least one property of the signal propagation of the wireless signals between the first and the second object, in particular the distance that the wireless signals have travelled and/or between the first and second object, wherein
a. f, in particular complex, measurement value vectors, in particular frequency measurement value vectors, each having a coordinates with a>=1 and with f>1, in particular with f>3, in particular f>10, with a given order, in particular as a complex measurement value matrix, in particular with f rows and a columns or f columns and a rows, are provided which in particular span a measurement value space, and wherein an autocorrelation matrix with a vector number smaller than f, in particular with a smaller number of columns and/or rows than that of the measurement value matrix, is formed from the set of measurement value vectors, in particular measurement value matrix, by means of spatial smoothing, wherein
b. for performing spatial smoothing, a plurality of subspace matrices each having a number of measurement value vectors, in particular a number of column or row vectors, less than f, in particular a smaller number of columns and/or rows than that of the measurement value matrix, are formed and wherein the subspace matrices are each correlated with themselves and the subspace matrices correlated with themselves, in particular weighted, are added up, characterised in that the subspace matrices are formed in such a way that
c. in each case a selection with the same number for all subspace matrices in said order at least partially in each case, in particular in each case, of non-adjacent measurement value vectors, in particular rows or columns of the measurement value matrix, forms a subspace matrix and/or that
a first subset of the subspace matrices is formed in such a way that a subspace matrix of the first subset is formed in each case by a selection with the same number of measurement value vectors, in particular rows or columns of the measurement value matrix, for all subspace matrices, wherein the arrangement of the selected measurement value vectors in the subspace matrix is as in said order, and in that a second subset of the subspace matrices is formed such that a subspace matrix of the second subset is formed in each case by a selection with the same number of modified measurement value vectors for all subspace matrices from a modified measurement value vector set, in particular a modified measurement value matrix, and in that the modified measurement value vector set, in particular the modified measurement value matrix, is formed by selecting measurement value vectors and reversing their order and inverting the complex or real component of all coordinates of the modified measurement value vector set, the arrangement of the selected measurement value vectors in the subspace matrix of the second subset corresponding in each case to the reverse order.

A measurement value vector, which is in particular determined by a frequency measurement value vector, is in particular formed in each case from at least a, in particular exactly a, in particular complex, measurement values on signals of a first object received at a second object, with at least approximately identical frequencies via a antenna paths. Different frequency measurement value vectors differ in particular by different, i.e. in particular not approximately identical, frequencies of the signals on which their measurement values were taken.

In particular, a measurement value matrix has frequency measurement value vectors and antenna measurement value vectors as columns or row vectors.

In particular, an antenna measurement value vector is formed from at least f, in particular exactly f, in particular complex, measurement values on signals of a first object received at a second object, at f different frequencies via a common antenna path. Various antenna measurement value vectors differ in particular in the antenna path used to generate their measurement values.

The measurement value vectors, in particular row or column vectors, contain the measurement values of a wireless signal or wireless signal round trip as values, in particular as their coordinates. The number of values or coordinates in a vector can, for example, correspond to the number of antenna paths. This means in particular the number of different combinations of receiving and transmitting antennas used. The number of measurement values and/or coordinates in the frequency measurement value vector can also be one, but is in particular greater than or equal to two. Said order can be determined by the arrangement in a matrix, but can also be separated from this by a predetermined order and/or by numbering, indexing or other means of the measurement value vectors.

As a rule, the measurement values are complex. In particular, these measurement values are each determined by a value dependent on the received amplitude, such as a standardised amplitude, an energy or a power, and a phase value, whereby this is in particular the phase shift due to the signal transmission from the first to the second object or the signal round trip between the two objects. The measurement values can also be pre-processed, for example the phase value can be calculated first or can be an average of measurements on several signals at the same frequency. The phase value can also be a phase change calculated from the signal propagation time due to the distance between the first and second object. An equivalent phase change can be calculated on the basis of the propagation time and the frequency.

When forming the subspace matrices, only a part of the measurement value vectors, i.e. in particular either columns or rows of the measurement value matrix, is selected and written to the subspace matrix. This reduces the size of the subspace matrix compared with the measurement matrix. However, the selection for forming the modified set of measurement value vectors can also include all measurement value vectors, but in particular it does not include at least those that were used to form the subspace matrices of the first subset. If the complex or the real component of all coordinates of the modified set of measurement value vectors is inverted, it is important that only the complex or the real component is inverted, not both. The inversion is thereby performed in particular identically for all selected measurement value vectors.

The number of subspace matrices can be selected based on the desired accuracy, the accuracy of the computing unit used and the available computing time. It can be less than, equal to or larger than the number of measurement value vectors. The smaller it is selected, the less computing power is required.

In particular, its size is selected such that it is 10 to 50×the number of antenna paths being considered. It is also sufficient to select only one antenna path and the antenna paths can also be considered individually or separately, so that subspace matrices with, for example, a size of 10 to 50×1 are also possible.

In some applications, especially when working with CAPON's method or the inverse of the autocorrelation matrix, it is expedient to select the number of subspace matrices not significantly less than or not less than the number of coordinates of the subspace matrix for one antenna path in each case, in particular not less than 75% of the number.

The addition of the subspace matrices can be weighted, in particular based on the quality of reception of the measurement value vectors, frequency measurement value vectors and/or antenna measurement value vectors contained. A quality metric can thus be used as a factor for the weighting. For example, the quality or quality metric can be determined for each measurement value vector contained and a metric of the subspace matrix can be derived from this, for example by an aggregation, an average value, a minimum and/or maximum. The quality or quality metric of a measurement value vector can be determined, for example, by taking several measurements on the same signal in close succession, which are averaged in particular to form the measurement value. A value that is anti-proportional to the spread, for example variance or standard deviation, of the measurements can be used as the quality metric. For example, the spread of the received amplitude, power and/or phase shift due to the signal transmission, in particular distance, can be used. As a result, the quality of the autocorrelation matrix can.

The method can be used in particular as part of one or more of the following steps:

Transmission of a plurality of wireless signals at different first frequencies, in particular with different first antennas, from a first object and reception at a second object, in particular with different second antennas, and optionally also transmission of a plurality of wireless signals at different second frequencies, in particular identical or similar to the first frequencies, in particular with different antennas, in particular the second antennas, from the second object and reception at the first object, in particular with different antennas, in particular the first antennas.

This can be carried out in particular in a frequency hopping process in which, for example, signals with frequencies changed by a fixed frequency interval are emitted one after the other at a fixed time interval.

Determination of amplitude values, for example amplitude, corresponding to the received amplitude, or received power and phase values, which are due to the phase shift caused by the propagation from one object to the other object or the round trip, in particular the distance between the objects.

Determination of phase values in each case for a frequency or frequency span, in particular from the first and/or second frequencies, indicating the phase shift of the signal transmission from the first to the second object or by the signal round trip, in particular on the basis of the distance between the objects.

Generation of a plurality of measurement values, each consisting of an amplitude value and a phase value, in particular as a complex number.

Generation of measurement value vectors or a measurement value matrix containing them as rows or columns. In the frequency measurement value vectors, the components of the measurement value vectors are in particular each determined by a measurement value of an antenna path. A frequency measurement value vector is formed in particular from measurements on one or more signals of a first and/or second frequency. In particular, in the case of a signal path only from the first to the second object, it is formed by measurements on signals of a first frequency, and in the case of a signal round trip, it is formed from measurements on signals from the first to the second object at a first frequency and on signals from the second to the first object at a second frequency, with the first and second frequencies in particular having a relative deviation of less than 500 kHz, in particular less than 100 kHz, and in particular being identical. In particular, the frequencies are selected to be so similar that the product of the time inaccuracy of the determination of the time of measurement of the measurement value with the frequency difference is less than 0.05, which would correspond to a phase jitter of 18°.

Signals with a constant frequency, in particular continuous wave signals, are particularly suitable as wireless signals Data can also be modulated onto them. The measurement value vectors can then be used to create the autocorrelation matrix.

The subspace matrices can each be formed by selecting measurement value vectors, in particular frequency measurement value vectors, and transferring these to the respective subspace matrix. A uniform pattern is generally used for this that is identical for each selection in each subspace matrix, at least of one subset. If several, in particular two, subsets of the subspace matrices are used, the selection rule in the two subsets is in particular similar, identical or a mirror image.

In particular, the measurement value vectors for the subspace matrices are selected according to the following scheme:

Let v(p) be the measurement value vectors, in particular frequency measurement value vectors, of the set of measurement value vectors, in particular frequency measurement value vectors, where p is from 0 to f−1

Let U(j) be the subspace matrices, each with k frequency measurement value vectors, where k<f and u=0 . . . k−1 and U(j,u) the u-th frequency measurement value vectors of the subspace matrix U(j)

$$U ( j , u ) = v ( j * A + C + u * B ) ,$$

$$and / or$$

$$U ( j , u ) = v * ( ( f - 1 ) - ( j * A + C + u * B ) )$$

$$and / or$$

$$U ( j , u ) = - v ( ( n - 1 ) - ( j * A + C + u * B ) )$$

where in particular B is not a divisor of A and/or in particular all j*A<>u*B for all j and u. j from the set of positive integers runs in particular from 1 to jmax with jmax being chosen such that (j*A+C+u * B) is always <=(f−1).

Where v* is the complex conjugate of v.

It is preferable to form a first subset with j from 1 to jm according to U(j,u)=v(j*A+C+u * B) and a second, in particular identical in number, subset with j from jm+1 to jmax according to

$$U ( j , u ) = v * ( ( f - 1 ) - ( j * A + C + u * B ) )$$

$$or$$

$$U ( j , u ) = - v ( ( f - 1 ) - ( j * A + C + u * bB ) ) ,$$

$$where - v = - real part ( v ) + i * ( imaginary part ( v )$$

With particular advantage, the U(j,u) to the U(j, u+1) for all j have a fixed amount of the frequency spacing and/or amount of the time spacing of the measurements on the received signal on which they are based and/or the transmission of the signal on which the measurement was made, but which can be different for each u, for example delta t(u) and/or delta F(u). This is particularly useful for increasing accuracy in the case of widely moving systems. This becomes less important if the distance between the objects is approximately constant and/or the wireless environment is approximately constant. For example, with identical time intervals and frequency intervals of the signals, this is even the case with constant delta_t (=time interval) and delta_F (=frequency step). This makes it particularly easy to select the measurement value vectors while fulfilling the advantageous selection condition. If subsets of the subspace vectors are used (first part), Delta_t(j|1 . . . jm, u)=−Delta_t(j|jm+1 max, u) and/or Delta_F(j 1 . . . jm, u)=−Delta_F(j|jm+1 . . . max, u) can also apply for the second part where, for example j|1 . . . jm means that j lies in the range from 1 to jm.

It is preferable if the measurement value vectors of the subspace matrices are selected such that a time and/or frequency interval pattern between the measurement value vectors determined in a subspace matrix is approximately identical, in particular identical, for all subspace matrices or all subspace matrices of the first subset and, in particular, the same pattern, or the same pattern with reversal of the time and/or frequency interval also applies to all subspace matrices of the second subset, or applies in inverted form. In particular, frequencies with an interval of less than 500 kHz, in particular less than 100 kHz, are considered to be approximately identical. In particular, the frequencies are selected so similar that the product of the time inaccuracy of the determination of the time of measurement with the frequency difference is less than 0.05, which would correspond to a phase jitter of 18°.

With particular advantage, the subspace matrices are formed in such a way that the selections of the measurement value vectors of the subspace matrices are different, in particular each measurement value vector only occurs in one subspace matrix. This reduces the computing time while maintaining a relatively high accuracy.

Preferably, the coordinates of the measurement value vectors, in particular in the f rows or f columns, each contain the complex measurement values of, in particular, one signal transmission or of, in particular, one signal round trip, in particular at one frequency.

The first and second subsets each have advantageously the same number of subspace matrices. This makes the computation particularly accurate. In particular, they are not formed from the same frequency measurement value vectors. The formation from the same frequency measurement value vectors also includes the formation in which a specific frequency measurement value vector is used in one subspace matrix and its complex conjugate or a product of the specific frequency measurement value vector and a scalar, even negative, is used in another. This increases the accuracy in relation to the computing time.

With particular advantage, the subspace matrices of the first subset and the second subset are not formed from measurement values of measurements on the same received signal set, in particular the first subset does not include frequency measurement value vectors, in particular, measurement values on received signals, which the second subset includes, in particular the frequency measurement value vectors, in particular rows or columns, from which the subspace matrices of the first subset are formed, are disjunct from the frequency measurement value vectors, in particular rows or columns, their complex conjugate or with a scalar, also negative, multiplied measurement value vectors, from which the subspace matrices of the second subset are formed. This increases the accuracy in relation to the computing time.

In some embodiments or environments, it can be of great advantage if not all measurement value vectors, in particular rows or columns, are included in the subspace matrices. In particular, in relation to the time of the measurement and/or the transmission of the signal on which the measurement was made and/or neighbouring measurement value vectors in relation to its frequency, are not included in the measurement value vectors included in the subspace matrices. For example, every second measurement value vector can be omitted in a sequence according to time and/or frequency. Measurement value vectors taken from signals with noticeably deviating received energy, bandwidth and/or fluctuation can also be omitted. As a result, the computing time can be significantly reduced without major losses in terms of accuracy, and in some cases the accuracy can even be improved, especially if received signals that are particularly disturbed by the selection or dominated by long signal paths are not used.

Advantageously, the first subspace matrix can be formed such that, starting with an A-th measurement value vector, all B-th or a predefined number of B-th measurement value vectors are included in the subspace matrix and this is repeated for all subspace matrices or all subspace matrices of the first subset, wherein A is increased by a predefined value, wherein B is in particular not equal to A, and in particular B is not a divisor of A. A and B are integers, in particular positive integers.

Preferably, the frequency measurement value vectors, in particular rows or columns, are each formed from measurement values on a wireless signal that was transmitted from a first to a second object at a frequency, or are formed from measurement values of a signal round trip, whereby in particular the phase change resulting from the transmission, in particular distance, between the objects is determined and/or a value dependent on the received amplitude is determined and in particular the measurement values are determined by complex numbers, in particular each formed from the value dependent on the received amplitude and the phase change. In the case of a signal round trip, the frequencies for the outward and return paths are in particular approximately identical. A frequency value that corresponds to one of the two frequencies or a frequency that lies between them is then used in particular to determine frequency intervals.

With particular advantage, in order to improve the accuracy and reduce the computing time, the measurement value vectors, in particular measurement values and/or measurement value matrix, are subjected to filtering and/or smoothing, in particular before spatial smoothing. For example, an IIR filter, an FIR filter and/or an FFT analysis and the removal of high frequency components can be considered. This is particularly advantageous for avoiding negative effects due to rounding errors, especially with 32-bit floating point numbers, when calculating eigenvectors and/or eigenvalues.

Advantageously, different antenna paths between the two objects are used to increase the accuracy, in particular each frequency measurement value vector is formed from measurement values from reception at different receiving devices and/or from reception after transmission with different transmitting devices, in particular of the same wireless signal, and/or one of the rows and columns in each case has measurements on a received wireless signal, in particular at one frequency, and the other of the rows and columns contains measurement values from the transmission with different transmitting and/or receiving antennas, and/or the values in the measurement value matrix are complex and in particular each contain a statement on the received amplitude or power and on the received phase position and/or phase shift.

Preferably, the number of measurement value vectors in each subspace matrix is at least 30% less than f, in particular the number of rows or columns in the subspace matrices is selected at least 30% less than that of the measurement value matrix. This allows the computing time to be reduced with little loss, and in some cases even with an increase in accuracy.

Eigenvectors and eigenvalues can be calculated from the autocorrelation matrix. Methods are known for separating the noise from the signal using the eigenvalues. Further analyses of or using the autocorrelation matrix, for example on the basis of its inverse, are also known.

The autocorrelation matrix can also be used to separate signal components, for example to reduce the noise component in the autocorrelation matrix. A signal space can also be defined in the autocorrelation matrix on the basis of at least one eigenvalue and/or eigenvector computation, in particular in which the eigenvectors of the largest eigenvalues are considered to span the signal space. The number of eigenvectors used here can, for example, be based on an absolute or relative specification or can be derived from the ratio of the values of the eigenvalues.

Test data or test vectors can be used to estimate the distance and/or other characteristics of the signal propagation.

It is possible to project test vectors into the signal space and/or an eigenvector space of the autocorrelation matrix and to determine their length in the signal space. The eigenvector space is preferably formed here from the eigenvectors of the autocorrelation matrix with the largest eigenvalues. The selection of the largest eigenvalues can, for example, be determined using a specified relative or absolute number or using the ratios of the values of the eigenvalues relative to one another. The longest test vector in the projection can then be regarded as the one that best matches the actual signal propagation and its properties, in particular distance, can be assumed to be those of the received signal. Averaging or interpolation of the properties of a plurality of largest projected test vectors can also be used.

The method preferably includes the computation and/or estimation of at least one property of the signal propagation, in particular distance, on the basis of a projection and/or multiplication with the auto-correlation matrix and/or its inverse Test values or vectors can be used for this that describe the signal to be received under given propagation conditions.

These can be determined as part of a calibration or calculated on the basis of a model. For example, these test vectors can each be multiplied individually by the inverse of the autocorrelation matrix and the shortest vector of the results can be used to determine the property, in particular as the one on which the model is based. Test vectors for different distances can be used here. For example, these test vectors can each be multiplied individually by the signal space of the autocorrelation matrix and the longest vector of the results can be used to determine the property, in particular as the one on which the model is based. Test vectors for different distances can be used here. In particular, test vectors all have the same length or a corresponding standardisation is carried out when considering the length after multiplication.

It is also possible to determine the phase shift difference between the signal component(s) with the largest eigenvalue(s) for the individual antenna paths or receiving antennas and to determine a direction of incidence of the signal from this, in particular assuming that the order of magnitude of the eigenvalues of the signal components is identical on all antenna paths or at all receiving antennas. In this way, the direction of incidence can be determined geometrically using the difference in phase change and knowledge of the arrangement of the receiving antennas, in particular by assigning the signal components between the individual antenna paths based on the relative size or sequence of the sizes of the eigenvalues.

It is particularly advantageous to use a floating point unit, in particular a digital signal processor comprising a floating point unit, to create the subspace matrices, their autocorrelation matrix and/or the summation and/or inversion and/or multiplication of the autocorrelation matrix or its inverse in each case with a test vector from a plurality of test vectors. This can lead to significant gains in speed.

Further advantages and possible embodiments of the invention are now explained purely by way of example and not by way of limitation, using examples and schematic figures:

For example, when transmitting 199 signals, each with a time interval of 10 ms and a frequency interval of 500 Hz via four antenna paths using two transmitting and two receiving antennas, a measurement value matrix can be formed with 200 frequency measurement value vectors and four complex coordinates each, from which subspace matrices are then formed. Four antenna measurement value vectors each with 200 coordinates then also exist or can be imaged. With the known spatial smoothing, the subspace matrices, for example with a size of 24 measurement value vectors each, would be formed as follows:
U(1): Frequency measurement value vectors 1-24
U(2): Frequency measurement value vectors 2-25 etc.
U(17): Frequency measured value vectors 175-199

According to the invention, these could be formed as follows:
U(1): Frequency measurement value vectors 1, 5, 9, 13, etc. 93
U(2): Frequency measurement value vectors 3, 7, 11, 15, etc. 95 etc.
U(54): Frequency measurement value vectors 107, 111, 115, etc. 199

This shows that the computing time can be significantly reduced. It has been seen that the accuracy of determining the property is reduced significantly less and can even increase, depending on the accuracy of the computation and the number of subspace matrices.

### BRIEF DESCRIPTION OF THE DRAWINGS

FIG. 1 is a flow chart showing a possible sequence in accordance with the present disclosure.

FIG. 2a shows an exemplary measure value matrix 1, where the complex coordinates are shown as boxes.

FIG. 2b shows an exemplary frequency measurement value vectors 4, where the selected to form a first subspace matrix are marked with arrows.

FIG. 2c shows an exemplary frequency measurement value vectors 5, where the selected to form a second subspace matrix.

FIG. 2d shows an exemplary choice of the frequency measurement value vectors 6, where a modified matrix to form a third subspace matrix.

### DETAILED DESCRIPTION

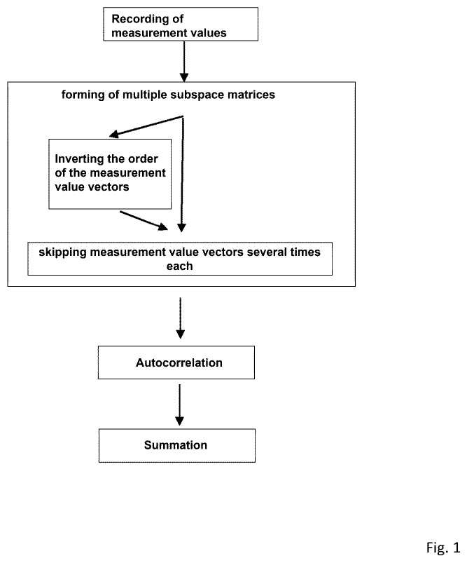

FIG. 1 illustrates a possible sequence. After the measurement values have been recorded, the subspace matrices are formed by skipping measurement value vectors several times and/or by inverting the order of the measurement value vectors. These are correlated with themselves and the results are cumulated.

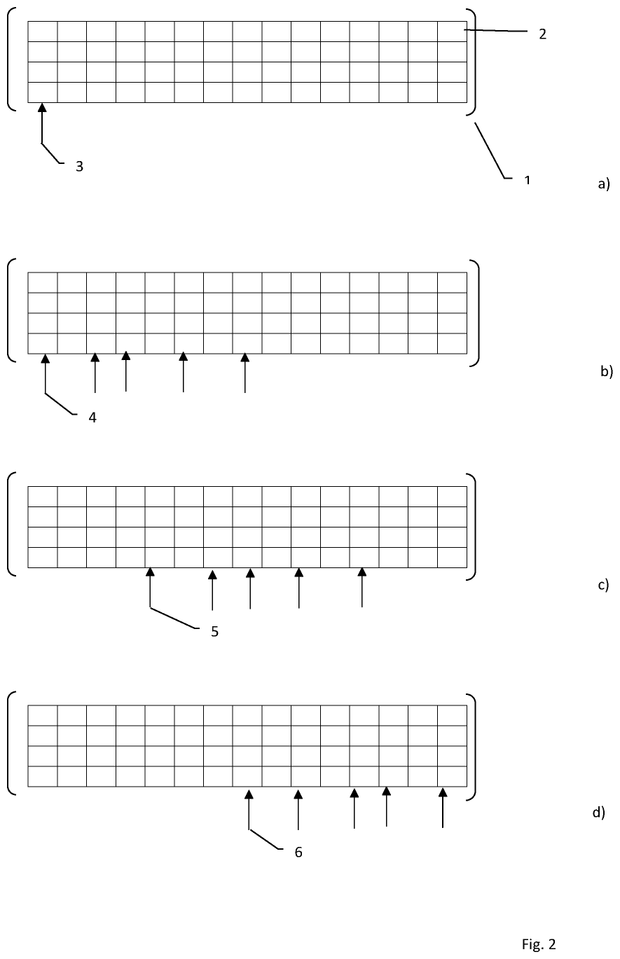

FIG. 2a) illustrates a measurement value matrix 1 whose complex coordinates are shown as boxes. It contains four antenna measurement value vectors 2 for four different antenna paths and fifteen frequency measurement value vectors 3. Here the antenna measurement value vectors are 2 row vectors and the frequency measurement value vectors are 3 column vectors. This can also be selected differently. The measurement value matrix 1 was created by measuring the amplitude and phase shift of signals at fifteen different equidistant frequencies at equidistant points in time. In FIG. 2b), the frequency measurement value vectors 4 selected to form a first subspace matrix are marked with arrows. FIG. 2c) shows the frequency measurement value vectors 5 selected to form a second subspace matrix It can be seen that the pattern of the frequency and time intervals of their measurements is identical in both selections. FIG. 2d) shows the choice of the frequency measurement value vectors 6 from a modified, here complex conjugate, matrix to form a third subspace matrix, in which, however, in addition to the complex conjugation of the measurement values in the subspace matrix, the order of the frequency measurement value vectors is reversed. This means that the order of the frequency measurement value vectors 4 and 5 was selected from left to right, while the order of the frequency measurement value vectors 6 was selected from right to left. The three subspace matrices formed according to FIGS. 2b, c and d are each individually correlated with themselves and then all added together to obtain the autocorrelation matrix.

1. A method for providing an autocorrelation matrix of measurement values of wireless signals between a first and a second object for determining at least one property of the signal propagation of the wireless signals between the first and the second object comprising:
a. f, frequency measurement value vectors, each frequency measurement value vectors having a coordinates with a>=1 and with f>1, are provided, and wherein an autocorrelation matrix with a frequency vector number smaller than f is formed from the set of frequency measurement value vectors by means of spatial smoothing; wherein
b. for performing spatial smoothing, a plurality of subspace matrices each having a number of frequency measurement value vectors are formed and wherein the subspace matrices are each correlated with themselves and the subspace matrices correlated with themselves are added up;
wherein the subspace matrices are formed in such a way that
c. in each case a selection with the same number for all subspace matrices in said order at least partially forms a subspace matrix, or that
a first subset of the subspace matrices is formed in such a way that a subspace matrix of the first subset is formed in each case by a selection with the same number of frequency measurement value vectors all subspace matrices, wherein the arrangement of the selected frequency measurement value vectors in the subspace matrix is as in said order, and in that a second subset of the subspace matrices is formed such that a subspace matrix of the second subset is formed in each case by a selection with the same number of modified frequency measurement value vectors for all subspace matrices from a modified frequency measurement value vector set and in that the modified frequency measurement value vector set is formed by selecting measurement value vectors and reversing their order and inverting the complex or real component of all coordinates of the modified measurement value vector set, the arrangement of the selected frequency measurement value vectors in the subspace matrix of the second subset corresponding in each case to the reverse of said order.

2. The method according to claim 1 in which the selections of the frequency measurement value vectors of the subspace matrices are different.

3. The method according to claim 1, in which the coordinates of the frequency measurement value vectors each contain the complex measurement values of, or each contain the complex measurement values of, one signal transmission or one signal round trip at one frequency, possibly via a plurality of antenna paths.

4. The method according to claim 1, in which the first and second subsets each have the same number of subspace matrices and in which measured signals which the second subset contains from which the subspace matrices of the first subset are formed, are disjoint from the frequency measurement value vectors from which the subspace matrices of the second subset are formed.

5. The method according to claim 1, in which not all frequency measurement value vectors are contained in the subspace matrices.

6. The method according to claim 1, in which the first subspace of the subspace matrices is formed such that, starting with an A-th frequency measurement value vector, all B-th or a predefined number of B-th frequency measurement value vectors are included in the subspace matrix and this is repeated for all subspace matrices or all subspace matrices of the first subset, wherein A is increased by a predefined value, wherein B is in particular not equal to A, and in particular B is not a divisor of A.

7. The method according to claim 1, in which the frequency measurement value vectors of the subspace matrices are selected such that a time or a frequency interval pattern between the frequency measurement value vectors determined in a subspace matrix is approximately identical for all subspace matrices or all subspace matrices of the first subset or the same pattern with reversal of the time or frequency interval also applies to all subspace matrices of the second subset.

8. The method according to claim 1, in which the frequency measurement value vectors are each formed from measurement values on a wireless signal which was transmitted from a first to a second object at a frequency or are formed from measurement values of a signal round trip, wherein the phase change or signal propagation time resulting from the transmission between the objects or the phase change calculated from the signal propagation time due to the distance between the first and second object is determined.

9. The method according to claim 1, in which the measurement value vectors are subjected to filtering or smoothing.

10. The method according to claim 1, in which each frequency measurement value vector is formed from measurement values from reception at different receiving devices or from reception after transmission with different transmitting devices and the other of the rows and columns contains measurement values from the transmission with different transmitting or receiving antennas or the values in the measurement value matrix are complex.

11. The method according to claim 1, in which the number of frequency measurement value vectors in each subspace matrix is at least 30% less than f.

12. The method according to claim 1, involving the computation or estimation of at least one distance determined or estimated based on at least one projection or multiplication with the autocorrelation matrix or involving reducing noise in the autocorrelation matrix or selecting a signal space in the autocorrelation matrix based on at least one eigenvalue/vector computation.

13. The method according to claim 1, in which a floating point unit is used to create the subspace matrices and the subspace matrices autocorrelation matrix or the summation or inversion or multiplication of the autocorrelation matrix or its inverse in each case with a test vector from a plurality of test vectors.

14. The method according to claim 1, wherein the measurement values are given by complex numbers, formed in each case from the value dependent on the received amplitude and the phase change.
